(19) United States
(12) Patent Application Publication
(10) Pub. No.: US 2002/0083182 A1
(43) Pub. Date: Jun. 27, 2002

(54) Real-time streamed data download system and method

(76) Inventors: Juan C. Alvarado, Cedar Park, TX (US); John M. Abney III, Houston, TX (US)

Correspondence Address: SCHLUMBERGER AUSTIN TECHNOLOGY CENTER, ATTN: PEHR B. JANSSON, INTELLECTUAL PROP LAW DEPT., 8311 NORTH FM 620, AUSTIN, TX, 78726, US

(21) Appl. No.: 09/741,618

(22) Filed: Dec. 18, 2000

(51) Int. Cl. G06F 15/16

(52) U.S. Cl. 709/231; 709/203

(57) ABSTRACT

A system, a method, and an article of manufacture for near real-time transfer of a datafile from a first computer to a second computer. The system comprises a first computer connected to a second computer over a computer network. These computers are operated such that on the first computer a server side script, responsive to a download request from the second computer, operable to launch an httpstreamproducer and to read and write data over the computer network. The httpstreamproducer operable to read a designated source file and simultaneously write data from the source file into a return-data-buffer connected to the server-side script and a read-while-write mechanism allowing the httpstreamproducer to read data from the designated source file while the designated source file is being written by a data producer program. The second computer a transaction handler class, each instance of which is operable to read and write data produced by an httpstreamproducer over the computer network and to write blocks of data to a destination simultaneously with receiving data from the computer network.

### TECHNICAL FIELD

This invention relates in general to the field of data transmission, and in particular to the real-time streamed download of data files over a computer network.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

Data transmission is one of the most important tools in many modern businesses. The ready availability of data is often the key to obtaining and maintaining a competitive edge. It can be the kernel of an enterprise.

Many businesses have their very foundation in the collection and dissemination of data. These enterprises range from the medical fields to aviation, from weather forecasting, to petroleum exploration and production.

Efficient and timely transmission of data is critical to the Petroleum Exploration and Production (E & P) industry. E & P activities are extraordinarily expensive undertakings which often take place in locations that are remote and distant from the offices where decisions are made. To maximize the value obtained from such endeavors, data is collected using a variety of surveying methods. These include land and offshore seismic surveys which are vast collections of multi-dimensional data, wireline well-logging in which data is collected from an electronic instrument lowered into a well, and measurements collected during the drilling operation itself.

Usually, if not always, the data acquired in from an E & P operation, be it seismic surveying, wireline well-logging, or logging while drilling, requires substantial processing before it is useful to make decisions. Such processing may include depicting the data graphically on a graphics workstation or executing one or several data interpretation programs. It is useful for that processing to occur concurrently with the acquisition of the data and transmission of the data from the field location to the location where the data is used, e.g., a data interpretation center or the headquarter of an oil company.

U.S. Pat. No. 5,864,772 describes a system in which petrophysical data collected at a data acquisition site is transmitted in near real time to a remote location. Near real time data transmission refers herein to transmission of data concurrently with data acquisition so that the acquired data is available for viewing or other processing at a remote location nearly at the same time as it is being acquired.

The World Wide Web and the HTTP protocol are designed with the goal of data delivery from a web server to a web browser.

In a standard web server to web browser communication a web page written, for example, in html is transmitted from a server computer using the HTTP protocol over the Internet to a web browser running on a client computer. The web browser interprets the web page and renders it on a screen on the client computer. The standard web environment further allows for file transfer from the server to the client. For example, a web page may have a hyperlink to a document stored on the server. By clicking on the hyperlink a user may cause the transfer of the file from the server to the client and either that the document is opened in a rendering program such as Adobe Acrobat or saved to a disk file.

It would be possible to extend the standard web technology to support real-time data transmission from the server side using CGI scripts, servlets or server scripts. In such an extension the received data would be stored in real-time by most web browsers. Without client-side custom software, the default behavior of the browser prevents external components from accessing the downloaded data until that data has been completely received. For that reason, real-time applications are not properly launched and data streams cannot be routed to non-file destinations, for example, digital gauges shown within the browser window.

RealNetworks Inc. (http://www.realnetworks.com) of Seattle, Wash. is a leader in media delivery over the Internet. RealNetworks offer several products for distribution of multimedia. RealNetworks also provides specialized, customizable developer tools for generic stream delivery. A drawback with RealNetworks solution is the requirement that custom software must be installed on the client side, namely, a specialized media server. Further, the RealNetworks products operate over a custom protocol—the Real-Time Streaming Protocol (RTSP).

Marimba Inc. (http://www.marimba.com) of Mountain View, Calif. is a leading provider of Internet solutions for automated deployment of applications and content. Such technology is commonly known as “Push Technology”. In Push Technology transactions are typically initiated at the server based on individual user information. Push Technology provides management features and content replication. However, because transactions are initiated at the server, Push Technology would be difficult to adapt to real-time data delivery initiated by the client and would require significant software installation on the client side and a large server side infrastructure.

File from Software Artisans Inc. (http://www.softartisans.com) of Brookline, Mass. is a product that provides software-managed upload and retrieval of documents over the World Wide Web using a signed Java applet.

Microsoft Remote Scripting (http://msdn.microsoft.com/scripting/remotescripting/default.htm) from Microsoft Corporation of Redmond, Wash. is a technology that allows browser side (client) scripts to invoke server side scripts using HTTP as the transport protocol and XML as the marshalling language. This technology is well suited for retrieving a small number of discrete items.

Ideally real-time transfer of data over the World Wide Web should be accomplished using standard protocols such as HTTP. Because it is cumbersome in decentralized organizations with many geographically dispersed locations to ensure that each such location has custom software available, to obtain a maximum benefit of using these technologies, it is desirable to minimize or eliminate the need for custom software at the client site.

From the foregoing it will be apparent that there is still a need to build on modern data transmission technologies such as the World Wide Web and the popular HTTP protocol to allow for real-time data streaming download from a web server to a browser using standard protocols and browser technology. It would be further desirable to provide a mechanism launch real-time applications at the client in conjunction with transfer of data in real-time using the HTTP protocol.

### SUMMARY OF THE INVENTION

In a preferred embodiment, the invention provides a mechanism for downloading files in real-time using the HTTP protocol without requiring extensive customization on the client side. In a system embodying the invention, the client side is capable of properly launching streaming applications and client side functionality is readily extended.

In one aspect, the invention may be embodied in a system for near real-time transfer of a datafile from a first computer to a second computer. Such a system has a first and a second computer both having a connection to a computer network and operable to communicate over the computer network using a standard protocol. On the server side computer a server side script, responsive to a download request from a second computer, is operable to launch an httpstreamproducer and to read and write data over the computer network using the standard protocol. The httpstreamproducer reads a designated source file and simultaneously writes data from the source file into a return-data-buffer connected to the server-side script. A read-while-write mechanism allows the httpstreamproducer to read data from the designated source file while the designated source file is being written by a data producer program.

The second computer has a transaction handler class, each instance of which is operable to read and write data over the computer network using the standard protocol and to write blocks of data to a destination simultaneously with receiving data from the computer network.

The first computer may also have a webserver for transmitting a webpage containing a list of files available for download by other computers in which case the second computer has a corresponding webbrowser for displaying the webpage containing the list of files available for download.

The second computer may also have a trusted applet operable, in response to a user selecting a file from the list, to create a transaction handler instance for receiving the selected file. The second computer may also include at least one stream handler class having at least one file interaction method for performing a file operation selected from the set creating a file, opening a file and writing to a file, wherein the transaction handler instance creates a stream handler instance appropriate for the file selected by the user.

The standard protocol may for example be http or WAP.

The first computer may execute a webserver for transmitting a webpage containing a list of files for download by other computers and the second computer, a webbrowser for displaying the webpage containing the list of files available for download. The second computer may also execute a trusted applet which, in response to a user selecting a file from the list creates a transaction controller instance operable to manage a plurality of file transfer threads. Each file transfer thread, in response to the request from a user to download a file, executes a transaction controller instance to create a transaction handler instance for receiving data from the first computer.

In the second computer, a stream handler class has a method for receiving data from the transaction handler instance and for writing data to a destination. The destination may be a data file, an application program that is a data consumer, or a database.

In another aspect, the invention may be a method for near real-time download of a file via a computer network. According to that aspect the download of a file is accomplished by operating a client to select a file for download from a server, establishing a network link between a first process executing on the client and a second process executing on the server; reading at the server the selected file one block of data at a time; transmitting the block of data as a continuous stream on the link from the server to the client; and at the client, receiving the data as a continuous stream from the link and writing the data to a destination file one block at a time simultaneously to receiving the data.

One link may be shared between multiple stream producer/stream handler pairs. If that is the case, the data stream is broken up into data chunks each corresponding to one stream producer/stream handler pair.

In another aspect the invention may be an article of manufacture, namely, a program storage medium having computer readable program code means embodied therein, wherein the computer readable program code comprises instructions giving direction to a computer system, having a server side computer, a client side computer, and a computer network connecting the server side computer to the client side computer. These instructions cause the computer system to produce a list of files available for download from the server side computer and to display the list of files available for download on the client side computer. Further the instructions cause the computer system to allow a user to select on or more of the files available for download. In response to the selection of a file from the list, the computer readable instructions direct the computer system to create a transaction handler instance, wherein each transaction handler is operable to read and write data over the network and to transmit a request over computer network indicating to the server to transmit the selected file. Further instruction include instructions to receive the request at the server and in response to receiving the request at the server read blocks of data from the selected file, place blocks of data in a return buffer, and to transmit the blocks of data from the return buffer to the client concurrently with reading additional blocks of data. Further instructions include instructions to receive the blocks of data at the client; and to write the blocks of data to a destination concurrently with receiving additional blocks of data.

In an alternative program medium aspect of the invention, the instructions include a web page producer, a web page reader, wherein the web page reader is operable to receive and to display a web page from the web page producer, a server side script operable to receive a download request and to launch an httpstreamproducer and to receive and transmit data over a standard protocol. The instructions also include an httpstreamproducer class each instance of which being operable to read a designated source file and simultaneously write data from the source file to a return-data-buffer; and a read-while-write mechanism providing the computer system instructions to enable the simultaneous reading from and writing to a data source. The server script causes the computer system to read data blocks from the return-data-buffer and to transmit the data blocks over the computer network. A transaction controller causes the computer system to receive a create instruction and in response to the create instruction, to create a transaction handler. The transaction handler is computer readable instruction that operate to cause the computer system to create an httpstreamhandler, to transmit get commands to a server side script, to receive blocks of data from the server side script; and to transfer the data to the httpstreamhandler. The httpstreamhandler is computer readable instructions to receive data from the transactionhandler; and to write data to a destination.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a system architecture diagram of a data delivery system embodying the invention.

FIG. 2 is a data flow diagram illustrating the operation of an embodiment of the invention.

FIG. 3 is an exemplary illustration of a web page listing files available for real-time download using an embodiment of the invention.

FIG. 4 is a block diagram illustrating the architecture for a system for near real-time download according to the invention.

### DETAILED DESCRIPTION OF THE PREFERRED EMBODIMENTS

As shown in the drawings for purposes of illustration, the invention is embodied in a novel data delivery mechanism that has the ability to transfer file data, from a server to a client, in real-time over HTTP and to launch real-time applications. Various techniques for data transfer using HTTP exist. However, these techniques require extensive custom software at the client and cannot readily extend the client side functionality.

The present invention provides a generic mechanism for downloading data over in near real-time. In a preferred embodiment, the invention uses the HTTP and HTTPS protocols to transfer data between a server and a client. The invention provides for extensibility hitherto not achievable.

By way of example, the invention is described herein in the context of a data delivery system for the Petroleum E & P industry in which data is transferred from a data acquisition site (e.g., an oil field being explored) to a data delivery site (e.g., an oil company headquarters). The invention is equally applicable to other data delivery scenarios which may benefit from the real-time delivery of data. One example is the management and exploration for underground water resources. Another example is the delivery of medical imaging data from a remote clinic to a hospital thereby allowing an expert physician aid a local physician in diagnosis and treatment of a patient. A third example is the delivery of video and sound images.

Furthermore, for exemplary purposes the invention is described below using the TCP/IP and HTTP data transmission protocols. The novel techniques described herein may be applicable to other existing and future protocols, for example, WAP.

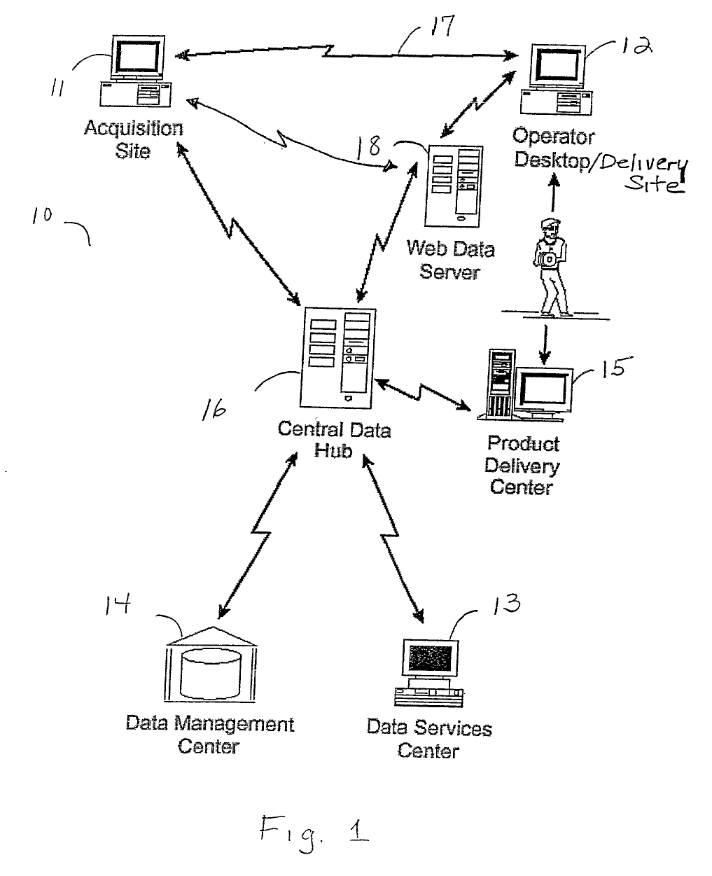

FIG. 1 is a system architecture diagram of the data delivery system 10. The data delivery system with its framework components has been designed around the data to be handled, the data workflow, the time domains to be accommodated, and the variety of computer platforms and network connections available. Specifically, it has been designed around three main sites or functions: the acquisition site (wellsite) 11, the delivery site (operators' office) 12, and the auxiliary sites such as the data services center 13, data management center 14, and product delivery center 15.

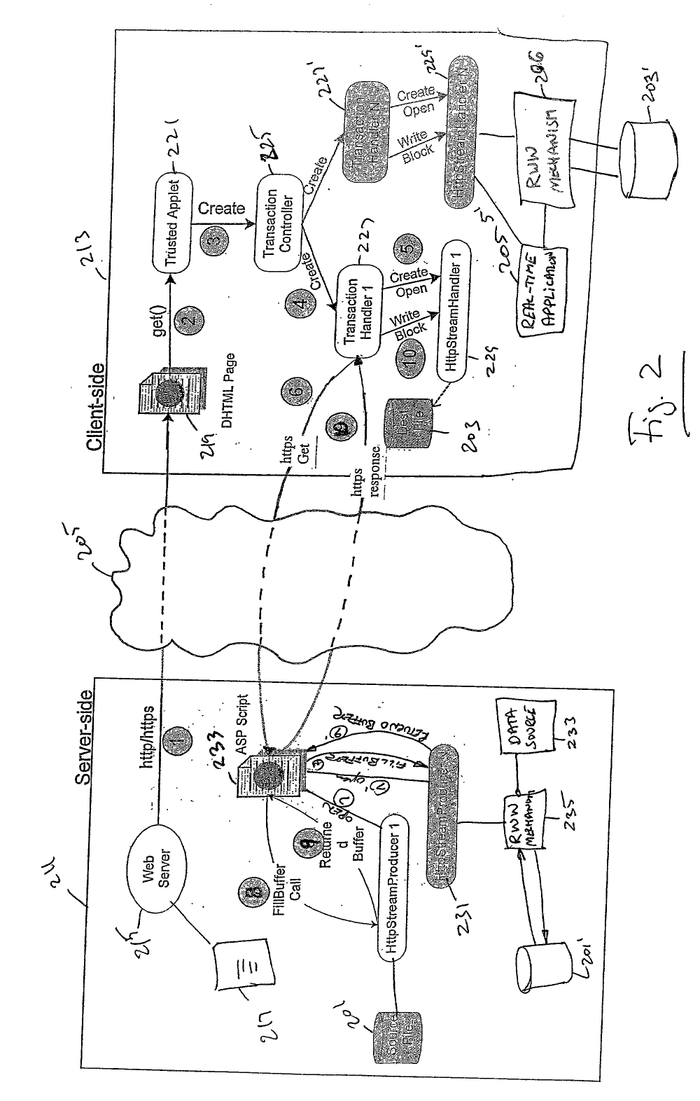

These sites communicate through a secure central data hub 16. Although not explicitly shown in FIG. 1, there may be multiple delivery sites, auxiliary sites and acquisition sites connected to the central data hub 16. The hub 16 receives data and forwards it to the required locations, either to the delivery site 12, to an auxiliary site 13-15 or to the acquisition site 11. Real-time data delivery to the delivery site (in this case the operator's desktop) 12 may be achieved through the use of the HTTP protocol through a web data server 18 as described below in conjunction with FIG. 2. The web data server 18 may be located either within a secure Intranet or within an associated secure enclave. The system can also accommodate point-to-point communication 17 directly between the acquisition site 11 and the delivery site 12.

Associated with this central data hub may be at least one product delivery center 15 comprised of specialized hardware and software systems designed specifically to generate hardcopy output in the form of products such as prints, tapes, films and CDs. The product delivery centers 15 may be located local to or in the operators' offices at the delivery site 12 or may be located virtually anywhere, removing the need for products to be generated at the acquisition site. Network transmission to the local product delivery centers 15 greatly reduces product delivery times from remote acquisition sites. The central data hub 16, product delivery center 15 and/or web data server of choice 18 are typically, but are not required to be, co-located within a single data service center. The data delivery framework is flexible and can be configured in a number of ways. There are many permutations on the data delivery theme depending upon the preferences of an operator at project time, as well as the communications configuration of a given acquisition site.

Desktop hardware and software tools located on the operator desktop at the delivery site 12 or on desktops at the data services center 13 complete the data delivery framework system components. The tools facilitate the reception, handling and manipulation of data, received either physically or electronically, and assist the operators with their next step decision process, be that data integration, interpretation, processing or archiving.

Data delivery from the acquisition site 11, including both measurement data and job status information, may be transmitted over satellite, landline, microwave, ISDN, cell phone, direct Ethernet connection or by any method that supports the TCP/IP protocol or any other protocol that supports HTTP. Generally, either the operator or the service company provides communications from the well site. In either case, the service company's data acquisition system must include hardware and software to allow it to communicate over any of these various links using standard protocols. Since data files can be written over hours (wireline) or days (for, example, in logging-while-drilling (LWD) operations), the ability to transmit files as they are being created is an essential facet, crucial to timely decision-making.

A router-based mobile connection solution, designed to facilitate connection of the acquisition unit to the most common communications methods encountered (‘standard modem’ dial-up, ISDN or Ethernet) may be used. Intended for mobile systems that must reconfigure their network connection on a regular basis, it consists of a router, power supplies and connectors, along with a software interface preconfigured and ready to enable any Internet Protocol (IP) based network application. It is designed for users who are not networking specialists and is straightforward to set up and run. The software ‘manager’ provides network and connectivity information and assists with troubleshooting, automatically indicating where and when a link has dropped out.

The data delivery system needs to transfer data from the often-remote temporary acquisition site 11 to a site hooked to an established communication infrastructure. The data delivery system uses, for example, the HTTP protocol as described below in conjunction with FIG. 2.

The data delivery system 10 provides for interactive, real-time, collaborative viewing of acquisition site data in the operator's office 12, which is a key and growing need in today's E&P industry. This is especially true relative to interpreting critical drilling and logging data, both of which are used for ‘next step’ formation evaluation and well construction decision-making.

Specifically, drilling mechanics, resistivity and sonic data are delivered in real-time to facilitate pore pressure analysis for selecting casing points and minimizing fluid loss while drilling. Sonic (Delta-T) data while drilling are delivered to data service centers for integration and correlation with seismic data in order to “put the bit on the seismic map” and update the well plan in real time. LWD data are delivered for real-time integration into a reservoir model for the purpose of geosteering.

Getting the logging information to the right people at the right time and place-wherever they may be relative to the well site-may be achieved through point to point communications 17 using an interactive remote witness software package, originally designed for point-to-point (standalone), two way transmission.

These established real-time services comprise just one facet of the data delivery framework. Real-time communication allows specialists to provide timely expertise on multiple wells worldwide from a central location or multiple locations. Remote witnessing not only provides optimal use of key staff, but also reduces travel costs and personnel exposure to hazardous environments. Further to this, it facilitates capture and dissemination of best practices, with the same staff collaborating on many wells in a specific field or region. Today's model for decision-making is thus becoming expert-centered versus asset-centered, including web-based real time remote witnessing.

FIG. 2 is a data flow diagram illustrating the real-time bulk data transfer according to the invention. The data flow diagram of FIG. 2 illustrates the transfer of a source file 201 residing on a server 211 to a client 213 where it may be stored as a destination file 203 or provided in real-time to a real-time application 205. The client side 211 may, for example, be the acquisition system 11 or the operator desktop 12 of FIG. 1. The server 213 may be the web data server 18 of FIG. 1.

In an embodiment of the invention, a data producer running on the server side produces data that is consumed by a data handler running on the client side. As an example, the data producer may be an HTTPStreamProducer 231 that reads from a data file 201. The corresponding data handler is a HTTPStreamHandler 229 running on the client side 213. The HTTPStreamProducer 231 and HttpStreamHandler 229 provide specific defined interfaces between the data transfer mechanism of the invention and the source and destination files.

The server side 211 and client side 213 are interfaced through a network 205. A user on the client side 213 interfaces with the system using a standard web browser such as Netscape Navigator or Microsoft Internet Explorer. Alternatively, the user uses a customized web browser that provides application specific functionality. In a preferred embodiment, the client side 213 functionality is provided by a web browser extended by a trusted Java applet 221, described herein below. The client-side functionality may also be implemented as a component that may be used by other application programs. An example of such an application are well-log interpretation and reservoir modeling systems, e.g., the Geoframe system from GeoQuest Corporation, Houston, Tex. In that embodiment of the invention, the application program would download a library component implementing the invention described herein without requiring the user to download or invoke a web browser.

In a preferred embodiment, a system according to the invention operates according to a pull-model. That is to say, a user at a client-side 213 initiates a data transfer from the server-side 211.

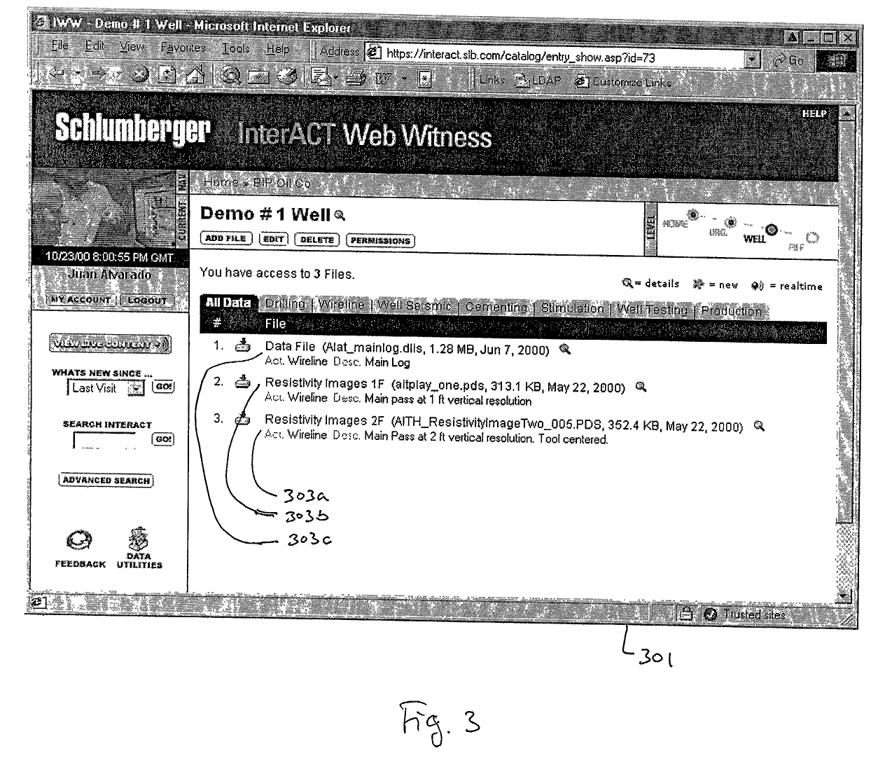

In a first step 1 the user browses to a DHTML web page 217 generated by a web server 215 on the server side 211 that displays links to source files available for download. FIG. 3 is a screen shot of an exemplary web page 301. Having browsed to the web page 217 the web page is transferred in a standard manner to the 213 where it is displayed 219 to the user. The web page 301 contains a list of files 303a, 303b, and 303c available for download.

In a second step 2 the user, still interacting through the web browser selects a file from the list of available source files. Typically the user would select the file by clicking on a link associated with the file. In the preferred embodiment, the selection of the file activates a trusted applet 221. A trusted applet is a Java applet with a cryptographic signature applied to it so the identity of the author is certified. The signature, along with special software code, allows the applet to perform privileged operations such as establishing network connections or writing to files, which are generally not allowed by the security system in the Java runtime (also known as the “sandbox”). To obtain the higher privileges the trusted applet 221 asks for those privileges using browser specific APIs for that purpose. The trusted applet 221 may have been previously loaded. If the trusted applet 221 does not yet reside on the client side 213, it is automatically downloaded from the server side 211. The trusted applet 221 has an entry point, the get( ) method. The get( ) method is an implementation of a signature (i.e., function name and arguments) agreed-upon by the trusted applet 221 and the DHTML code of the web page 217.

The browser at the client side 213 invokes and passes the URL (Universal Resource Locator) string representing the remote source file 201 to the get( ) method. The URL points to a server-side script 223 (in a Microsoft implementation, the server-side script is an Active Server Pages script). The arguments for the get( ) message are specified at the end of the URL in the standard HTTP GET syntax. The HTTP GET command is an HTTP command used by a client to request a server to return some data, e.g., a file. An example of the URL is:

http://ehub.com/downtest.asp?Handler=SerialFileHandler&Producer=SerialFil eProducer&LocalName=file.pds

In the URL the arguments begin with “?” and are delimited by “&”.

The next step, step 3, is to create a TransactionController instance. In the preferred embodiment, the get( ) method of the trusted applet 211 operates to create a TransactionController instance 225 in the thread that the get( ) method is executing in. The transaction controller 225 manages the worker threads that carry out the stream transfers. The transaction controller 225 creates new threads when the applet get( ) method is invoked, it forwards applet events (i.e., page transitions and applet shutdown) to the active threads, and shuts down the active threads when the browser exits.

In step 4, the TransactionController instance 225 creates a TransactionHandler thread 227 for the file to be downloaded. The TransactionHandler establishes a connection to a remote stream producer and moving data from the server-side ASP script 223 to a client-side HTTPStreamHandler instance 229. The HTTPSTreamHandler implements an open( ) method which when invoked creates a destination file.

In step 5, the TransactionHandler 227 creates the HTTPStreamHandler instance 229. If time-outs are enabled and no data is available the connection is timed out to prevent having open connections without activity. If the connection is timed-out, it is reestablished after a pre-defined waiting period. After this time-out management, the TransactionHandler 227 invokes the open( ) method of the HTTPStreamHandler 229. The open( ) method creates the destination file 203 and optionally launches the real-time application. The original URL string is passed to the open( ) call. The HTTPStreamHandler 229 modifies the arguments in the string as may be appropriate. The URL string is how the HTTPStreamHandler communicates with its server counterpart, the HTTPStreamProducer. In a preferred embodiment, a real-time file transfer system according to the invention provides an error-recovery mechanism. If a part of a file is already present on the client-side 213 the HTTPStreamHandler 229 indicates in the URL string how much of the file is present to the server-side 211.

Alternatively, the received data may be directed to a real-time application, for example, a data viewer such as Schlumberger's PDSView program. That scenario is illustrated in FIG. 2 using the TransactionHandler 227′ and the HTTPStreamHandler 229′. If the data is directed to a real-time application, in addition to opening a destination file, the HTTPStreamHandler 229′ launches the real-time application 205, step 5′. In an alternative embodiment, no destination file is opened and the data is directly streamed to the real-time application 205. A read while write mechanism 206 allows data to be written to a destination file 203′ simultaneously as being presented to the real-time application 205.

In the discussion here in, for purposes of illustration, two stream handlers are shown: HTTPStreamHandler 229 and HTTPStreamHandler 229′. In practice there is no limit on how many stream handlers operate in parallel.

In step 6, the TransactionHandler 227 attempts to connect to the server-side 211 by sending an HTTP GET request using the URL string (possibly modified, if appropriate). Over a successfully established connection, the TransactionHandler 227 (or TranactionHandler 227′) enters a state of being capable of receiving data from the server-side 211 via an https RESPONSE message. An HTTP GET message is a request from a client for a delivery of something (e.g., a file) specified in the argument presented to the HTTP GET. The HTTP RESPONSE message is the server's answer to the HTTP GET.

In the discussion here in, for purposes of illustration, two stream producers are shown: HTTPStreamProducer 229 and HTTPStreamProducer 229′. In practice there is no limit on how many stream producers operate in parallel. The HTTP protocol limits the number of connections between a client and a server to two. In one embodiment of the invention the stream of data from the server to the client may service multiple HTTP stream producer—HTTP streamhandler pairs by breaking up the stream into multiple request-response pairs, wherein each request-response pair corresponds to a portion of a file to be downloaded. In that scenario the transaction handlers 227 alternate in accessing the data stream in a round-robin fashion.

In step 7, when the connection has been established, in response to the get( ) message, the server-side script 223 creates an appropriate type of HttpStreamProducer 231. An HttpStreamProducer 231 and a HttpStreamhandler 229 work together, that is to say, these components agree on the structure and meaning of the data stream. For example, an HttpStreamProducer 231 that reads data from a database should be paired with an HttpStreamHandler 229 that is designed to interpret the database stream. The ASP script 223 parses the URL string and creates the right HttpStreamProducer 231 based on the name provided.

An HttpStreamProducer is a server-side component that implements the producer interface (a preferred embodiment producer interface is set forth in the code appendix). The producer interface defines how a stream producing agent provides services to the server-side script 233. This common interface allows any agent to be used without regard to how it is implemented. Thus, you could have a database stream producer, and a serial file stream producer, and either could be accessed by a single ASP script via the common interface. The ASP script 223 calls the open( ) method of the HttpStreamProducer 231 to open the source file to be transferred.

The source file may be a source file that is in the process of being generated, e.g., from a data source 233. A data stream is fed from the data source 233 to a read while write mechanism 235. The data may then be simultaneously written to a source file 201 ′ and transmitted to an HttpStreamProducer 231′.

For illustrative purposes two source files are shown: source file 201 and 201′. In practice many more files may exist or be in the process of being created on the server side 211.

The server-side script 223 calls the open( ) method of the HttpStreamProducer 231 or 231′ passing it the URL string as an argument. If the call succeeds, the SERVER-SIDE script 223 then repeatedly calls the getHeaderAt( ) method of the HttpStreamProducer to get any headers that should be passed to the client side 213 and adds these to the response message.

In step 8, to retrieve the data of the data file 201 or 201′, the server-side script 233 repeatedly calls the fillBuffer( ) method of the HttpStreamProducer 231 or 231′. Each call to fillBuffer( ) prompts the HttpStreamProducer 231 or 231′ to fill a buffer of data.

In step 9, the buffer of data that is returned from the call to fillBuffer( ) is written in a response message from the HttpStreamProducer 231 or 231′ to the server-side script 223. In a preferred embodiment, a system according to the present invention provides for real-time transfer of data from a serial data file. The code appendix includes an implementation of the HttpStreamProducer interface called SerialFileProducer. The SerialFileProducer implementation (i.e., one HttpStreamProducer instance 231) of the HttpStreamProducer interface operates to produce a data stream from real-time serial file 201′ using a Read-While-Write mechanism 235. If the HttpStreamProducer 231′ is a SerialFileProducer and the buffer represents bytes read from a file, e.g., source file 201′, that is being uploaded to the server-side 211.

In step 10, the server-side Script 223 upon receiving buffers of data from the HttpStreamProducer 231 or 231′ transmits the data buffer in an https response message to where the data buffer is received by the TransactionHandler 227. The response is streamed continuously to the client side 213 over an open https connection.

In step 11, the TransActionHandler 227 upon receiving data over the open https connection, calls the WriteBlock( ) method of the HttpStreamHandler 229 or 229′.

The TransActionHandler 227 and HttpStreamHandler 229 or 229′ for one transaction runs in a separate thread. When the transaction has been complete, i.e., all data associated with a file has been received and processed, the TransActionHandler 227 and HttpStreamHandler 229 shut themselves down.

The functionality of an embodiment of the invention is readily extended by adding a new HttpStreamProducer and a new HttpStreamHandler and plugging these components into the system. A user wishing to use the extension downloads the new HttpStreamHandler class from server-side 211. When a file is downloaded for use with the extension, the trusted applet 221 creates an instance of the new HttpStreamHandler. The transport of data between the server-side 211 and client-side 213 proceeds as described above.

In a preferred embodiment, the process described above in conjunction with FIG. 3 may be repeated for multiple files in parallel. While one or more file transfers are in progress the user may again select one of the available files from the web page 219 for download. This action by the user triggers the invocation of another get( ) on the trusted applet 221. The trusted applet 221 then directs the transaction controller 225 to create another transactionhandler instance 227 which, in turn, creates another HttpStreamHandler instance appropriate for this file download.

These further transaction handler 227 and HttpStreamHandler 229 execute in new and separate threads from each other, the trusted applet, and the previously executing transaction handlers 227 and HttpStreamHandlers 229.

Similarly on the server side 211, when the server-side Script 233 receives a further request for an additional file download, the server-side Script 233 creates a new HttpStreamProducer 231 instance appropriate for that file.

In one embodiment the communication between corresponding HttpStreamProducer-HttpStreamHandler pairs is carried out on a dedicated http connection between the server-side 211 and client-side 213. In an alternative embodiment, a fixed maximum number of connections are established. If the number of file transfers that are being carried out in parallel exceeds that maximum number, the client Java Runtime causes the files to be transmitted on the established connections in a shared fashion, for example, in a round-robin scheme.

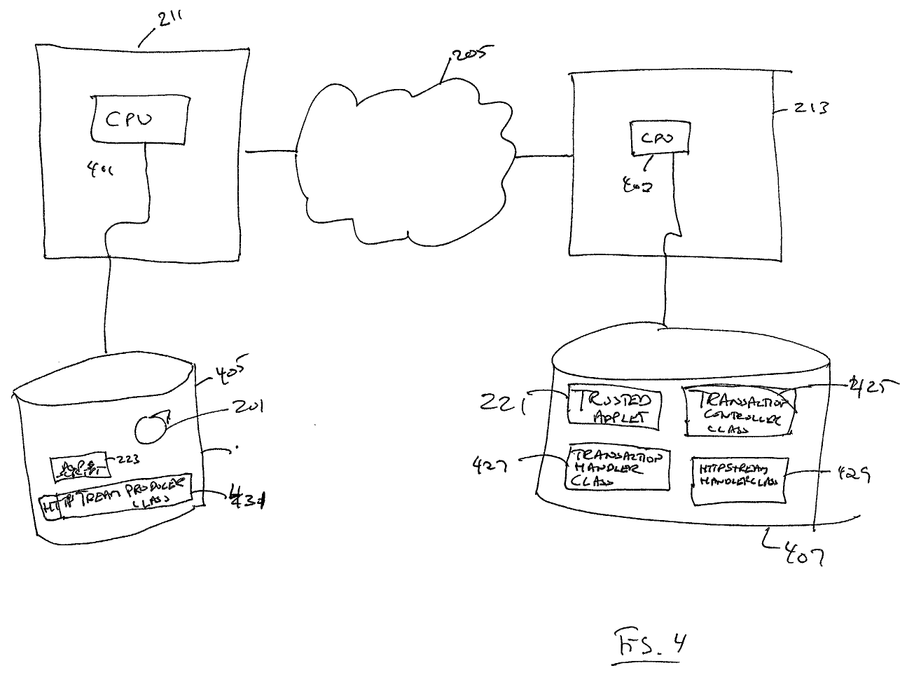

FIG. 4 is a block diagram showing the architecture for a system for near real-time download according to one embodiment of the invention. A server-side computer 211 is connected to a client-side computer 213 via network 205. The sever-side computer has a central processing unit (CPU) 401. Similarly, the client-side computer 213 has a central processing unit (CPU) 403. The server side CPU 401 is connected to one or more disk drives or other permanent storage system 405. For illustrative purposes, only one disk drive 405 is shown. A client-side computer 211 may have many disk drives or other permanent storage systems. The disk drive or storage system 405 stores the source files 201. Furthermore, the disk drive or storage system 405 stores the server-side script 223 and an HttpStreamProducer class 431.

To execute the method of the invention, for example, as described in conjunction with FIG. 2, the CPU 401 loads the server-side script 223. Appendix A contains an exemplary server-side script 223. As discussed above in conjunction with the discussion of Step 7 of FIG. 3, the server-side script creates an HTTPStreamProducer instance 231. That HTTPStreamProducer instance is derived from an HTTPStreamProducer class 431 stored on disk drive 405. Appendix B contains a program listing of an exemplary HTTPStreamProducer class 431.

Similarly, the description above in conjunction with FIG. 2 describes the client-side creation of Transaction Controller instance 225, TransactionHandler instance 227, HttpStreamHandler instance 229. These are derived from the Transaction Controller class 425, the TransactionHandler class 427, and the HttpStreamHandler class 429. These classes are stored on disk drive 407 which is connected to CPU 403. Furthermore, the Trusted Applet 221 is also stored on disk drive 407.

In one embodiment, the data stream is compressed. The HttpStreamProducer 231 and HttpStreamHandler 229 are directed to turn on compression through the URL passed via the HTTP GET (FIG. 2, step 6) and HTTP RESPONSE (FIG. 2, step 10) commands, respectively. The compression may, for example, be the compression algorithm provided through the standard JAVA runtime environment. Other compression algorithms may also be used. When compression is turned on, the HttpStreamProducer 231 is requested to provide a buffer of data through the fillbuffer( ) message (FIG. 2, step 8), it compresses the data placed in the buffer before providing the data in the ReturnBuffer( ) message (FIG. 2, step 9). The HttpStreamHandler 229, in turn, decompresses the data before writing the data to a destination file 203 or providing it to a real-time application 205.

One embodiment of the invention is implemented in the source code of the source code appendices, namely:

Appendix A—ClientAppletjava

Appendix B—Filedownload.asp

Appendix C—HttpStreamHandlerjava

Appendix D—SerialFileHandlerjava

Appendix E—SerialFileProducerjava

Appendix F—TransactionControllerjava

Appendix G—TransactionHandlerjava

Although a specific embodiment of the invention has been described and illustrated, the invention is not to be limited to the specific forms or arrangements of parts so described and illustrated. The invention is limited only by the claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A system for near real-time transfer of a datafile from a first computer to a second computer, comprising:
a first computer having:
a connection to a computer network and operable to communicate over the computer network using a standard protocol;
a server side script, responsive to a down-load request from a the second computer, operable to launch an httpstreamproducer and to read and write data over the computer network using the standard protocol;
the httpstreamproducer operable to read a designated source file and simultaneously write data from the source file into a return-data-buffer connected to the server-side script; and
a read-while-write mechanism allowing the httpstreamproducer to read data from the designated source file while the designated source file is being written by a data producer program; and
a second computer having:
a connection to the computer network and operable to communicate over the computer network using the standard protocol; and
a transaction handler class, each instance of which is operable to read and write data over the computer network using the standard protocol and to write blocks of data to a destination simultaneously with receiving data from the computer network.

2. The system of claim 1 wherein
the first computer further comprises:
a webserver for transmitting a webpage containing a list of files available for download by other computers;
the second computer further comprises:
a webbrowser for displaying the webpage containing the list of files available for download; and
a trusted applet operable, in response to a user selecting a file from the list, to create a transaction handler instance for receiving the selected file.

3. The system of claim 1 wherein
the second computer further comprises:
at least one stream handler class having at least one file interaction method for performing a file operation selected from the set creating a file, opening a file and writing to a file; and
wherein the transaction handler instance creates a stream handler instance appropriate for the file selected by the user.

4. The system of claim 1 wherein the standard protocol is http.

5. The system of claim 1 wherein the standard protocol is WAP.

6. The system of claim 1 wherein the server-side script implements an http GET command and the down-load request is an invocation of the http GET command of the server-side script.

7. The system of claim 1 further comprising an HttpStreamProducer class and wherein the HttpStreamProducer is an instance of the HttpStreamProducer class.

8. The system of claim 1 wherein
the first computer further comprises:
a webserver for transmitting a webpage containing a list of files for download by other computers;
the second computer further comprises:
a webbrowser for displaying the webpage containing the list of files available for download; and
a trusted applet operable, in response to a user selecting a file from the list, to create a transaction controller instance operable to manage a plurality of file transfer threads, wherein in each file transfer thread, in response to the request from a user to download a file, the transaction controller instance is operable to create a transaction handler instance for receiving data from the first computer.

9. The system of claim 8 wherein
the second computer further comprises:
a stream handler class having a method for receiving data from the transaction handler instance and for writing data to a destination.

10. The system of claim 9 wherein
the destination is a data file.

11. The system of claim 9 wherein
the destination is an application program that is a data consumer.

12. The system of claim 11 wherein
the destination is a database.

13. A method for near real-time download of a file via a computer network, comprising:
a) operating a client to select a file for download from a server;
b) establishing a network link between a first process executing on the client and a second process executing on the server;
c) reading at the server the selected file one block of data at a time;
d) transmitting the block of data as a continuous stream on the link from the server to the client; and
e) at the client, receiving the data as a continuous stream from the link and writing the data to a destination file one block at a time simultaneously to receiving the data.

14. The method of claim 13 wherein the server side script is an Active Server Pages script.

15. A method for near-real time download of a file via a computer network, comprising:
a) on a server producing a list of files available for download;
b) on a client retrieving the list of files available for download;
c) selecting a file from the list;
d) in response to the selection of a file from the list, creating a transaction handler instance, wherein each transaction handler is operable to read and write data over the network;
e) operating the transaction handler instance to transmit a request over the computer network indicating to the server to transmit the selected file;
f) receiving the request at the server;
g) in response to receiving the request at the server:
reading blocks of data from the selected file;
placing the blocks of data in a return buffer;
transmitting the blocks of data from the return buffer to the client concurrently with reading additional blocks of data;
h) receiving the blocks of data at the client; and
i) writing the blocks of data to a destination file concurrently with receiving additional blocks of data.

16. The method of claim 15 further comprising:
j) on the client side, launching an application program; and
k) upon receipt of blocks of data at the client, transferring the blocks of data to the application program.

17. The method of claim 15 wherein the step (a) of producing a list of files available for download comprises the step of creating a web page including the list of files.

18. The method of claim 17 further comprising the step of transmitting from the server to the client the web page including the list of files.

19. An article of manufacture comprising a program storage medium having computer readable program code means embodied therein, wherein the computer readable program code comprises instructions to cause a computer system, having a server side computer, a client side computer, and a computer network connecting the server side computer to the client side computer, to:
produce a list of files available for download from the server side computer;
display the list of files available for download on the client side computer;
allow a user to select on or more of the files available for download;
in response to the selection of a file from the list, create a transaction handler instance, wherein each transaction handler is operable to read and write data over the network;
transmit a request over computer network indicating to the server to transmit the selected file;
receive the request at the server;
in response to receiving the request at the server:
read blocks of data from the selected file;
place blocks of data in a return buffer;
transmit the blocks of data from the return buffer to the client concurrently with reading additional blocks of data;
receive the blocks of data at the client; and
to write the blocks of data to a destination concurrently with receiving additional blocks of data.

20. The article of manufacture of claim 19, wherein the destination is a computer file.

21. The article of manufacture of claim 19, further comprising computer readable program code instructions to cause the computer system to:
launch an application program on the client side; and
wherein the destination is the application program.

22. The article of manufacture of claim 19, wherein the destination is a database.

23. An article of manufacture comprising a program storage medium having computer readable program code means embodied therein, wherein the computer readable program code comprises instructions to cause a computer system, having a server side computer, a client side computer, and a computer network connecting the server side computer to the client side computer, to transfer selected files from the server side to the client side, the instructions comprising:
a web page producer;
a web page reader, wherein the web page reader is operable to receive and to display a web page from the web page producer;
a server side script operable to receive a download request and to launch an httpstreamproducer and to receive and transmit data over a standard protocol;
an httpstreamproducer class each instance of which being operable to read a designated source file and simultaneously write data from the source file to a return-data-buffer; and
a read-while-write mechanism providing the computer system instructions to enable the simultaneous reading from and writing to a data source;
wherein the server script is operable to read data blocks from the return-data-buffer and to transmit the data blocks over the computer network;
a transaction controller operable to receive a create instruction and in response to the create instruction, to create a transaction handler;
a transaction handler operable:
to create an httpstreamhandler;
to transmit get commands to a server side script;
to receive blocks of data from the server side script; and
to transfer the data to the httpstreamhandler;
an httpstreamhandler operable:
to receive data from the transactionhandler; and
to write data to a destination.

24. A system for near real-time transfer of a datafile from a first computer to a second computer, comprising:
a first computer having:
a connection to a computer network and operable to communicate over the computer network using a standard protocol;
a server side script operable to receive download requests from a second computer and, responsive to each download request from the second computer, operable to launch an httpstreamproducer and to read and write data over the computer network using the standard protocol;
each httpstreamproducer operable to read a designated source file and simultaneously write data from the source file into a return-data-buffer connected to the server-side script; and
a read-while-write mechanism allowing the httpstreamproducer to read data from the designated source file while the designated source file is being written by a data producer program;
wherein the server side script is further operable to transmit blocks of data from the plurality of httpstreamproducers over the connection; and a second computer having:
a connection to the computer network and operable to communicate over the computer network using the standard protocol;
a transaction controller operable to send data to and receive data from the server side script, and further operable to marshall the data to an appropriate transaction handler; and
a transaction handler class, each instance of which is operable to read and write data over the computer network using the standard protocol and to write blocks of data to a destination file simultaneously with receiving data from the computer network.
